(19) United States
(12) Patent Application Publication
(10) Pub. No.: US 2026/0274002 A1
(43) Pub. Date: Sep. 17, 2026

(54) BICYCLE COMPONENT

(71) Applicant: DT SWISS INC., Grand Junction, CO (US)

(72) Inventors: Nicholas OMLIN, Rapperswil (CH); Andreas TSCHANZ, Lengnau (CH); Thomas GASSER, Detligen (CH); Nils VERHOEVEN, Biel (CH); Timo PRIES, Spardorf (CH)

(21) Appl. No.: 19/563,477

(22) Filed: Mar. 11, 2026

(30) Foreign Application Priority Data
Mar. 13, 2025 (DE) 10 2025 109 711.9

(51) Int. Cl. B60B 27/04; B60B 27/00; B60B 27/02; F16D 41/30

(52) U.S. Cl. CPC B60B 27/047; B60B 27/0026; B60B 27/023; F16D 41/30; B60B 2900/133; B60B 2900/541

(57) ABSTRACT

A bicycle component, having a ring unit and a freewheel component of a freewheel, the freewheel component is a radially outer freewheel component and has an inner toothing for engaging pawls of a radially inner freewheel component to transfer a driving power in the driving direction. The outer freewheel component and the ring unit are coupling components couplable to one another and respectively have a coupling toothing for engagement with one another and are mutually rotatable about a central rotation axis. In an installation position, the ring unit and the (outer) freewheel component are movable circumferentially by a defined pivot angle relative to one another between a driving position and a rest position so that, prior to the beginning of a torque transmission, a coupling component is rotated in the drive direction before a torque transmission is performed, if the two coupling toothings were located in the rest position.

### BACKGROUND

The present invention relates to a bicycle component for an at least partially muscle-powered vehicle, and in particular a bicycle, and comprises a ring unit and a freewheel component of a freewheel device radially accommodatable therein, wherein the freewheel component is designed as a radially outer freewheel component and has an inner toothing, which is designed for engaging pawls of a radially inner freewheel component in order to transfer a driving power in the driving direction. The outer freewheel component and the ring unit radially surrounding the same are designed as coupling components able to be coupled to one another and respectively have a coupling toothing for engagement with one another and are rotatable about a mutual, central axis of rotation.

The most varied of bicycle components with freewheels are known from the prior art. Rear wheel hubs are regularly equipped with a freewheel, wherein toothed disc freewheels, in which two toothed disc devices with spur toothing are used, are also used by the applicant. The axial engagement elements on the spur sides engage with one another for torque transmission and are separated from one another in the axial direction in the free wheeling state.

Rear wheel hubs are often also used with a pawl free wheel, in which multiple pawls are provided, which, for torque transmission, rise up about an axis parallel to the hub axis and engage in an inner toothing of the hub housing with the radially outer end of the pawl. When the rider stops pedaling, the pawls disengage and the freewheeling state occurs.

In particular, in the case of full-suspension bicycles, it may occur when riding downhill, due to the terrain, or during jumps, that the geometry of the drive system changes slightly, such that during a compression, the rotor of the rear wheel hub is then possibly accelerated so that the freewheel couples and unintentionally drives the chain backwards, even though the rider does not step on or move the pedals. The rider then feels a so-called pedal kickback in the pedal, which may be unpleasant. This reverse driving of the chain leads to a kickback of the pedal, affects the body and the power of the rider, and negatively influences the same. Even if the pedal kickback is often not associated as such by a rider on an uneven surface.

In order to prevent pedal kickback, O-Chain (https://www.ochain.bike/pages/for-nerds) has developed a mechanism, which is mounted on the pedal crank and provides an adjustable angular range, only after which a torque transmission takes effect at the beginning of pedaling. Thus, in a corresponding way, a pedal kickback is prevented or not noticed by the rider. The system, which has become known and is available on the market, functions satisfactorily. The disadvantage, however, is that an additional component is required, which makes the entire system more complicated and additionally also requires maintenance.

A bicycle hub has become known from US 2024/0157728 A1, which is equipped with a pawl freewheel, and which enables the adjustment of a dead angle, if necessary, after which a torque transmission is carried out. When necessary, an adjustment part is introduced on the pawl carrier, in order to reduce the dead angle, if necessary, or to increase the dead angle by removing the adjustment part. This freewheel hub also functions satisfactorily. It is disadvantageous that a new hub is necessary. It is questionable whether the product based on this is already generally obtainable. The complex design is also disadvantageous.

It is therefore the object of the present invention to provide an improved bicycle component for at least partially muscle-powered vehicles, and, in particular, bicycles.

### SUMMARY

A bicycle component according to the invention is for an at least partially muscle-powered vehicle, and, in particular, a bicycle. The bicycle component according to the invention comprises at least one ring unit and at least one freewheel component (centrally accommodatable therein) of a freewheel device. The freewheel component is designed as a radially outer freewheel component and has an inner toothing, which is designed for engaging pawl elements and, e.g., pawls of a/an (other accommodatable in turn therein) radially inner freewheel component in order to transfer a driving power in the driving direction. The inner freewheel component does not have to be a component of a retail unit of a bicycle component; however, it may be such a component. The outer freewheel component and the ring unit are designed as coupling components able to be coupled to one another and respectively have a coupling toothing for engagement with one another and are mutually rotatable about a central axis of rotation. In at least one installation position, the ring unit and the (outer) freewheel component are movable in the circumferential direction about a defined pivot angle relative to one another between a driving position and a rest position, so that, prior to the beginning of a torque transmission, a coupling component must first be rotated in the driving direction until a torque transmission is or may be carried out, if the two coupling toothings were previously located in the rest position. Then or afterwards in the driving position, a torque may be transmitted in the driving direction.

The bicycle component according to the invention has many advantages. One substantial advantage of the bicycle component according to the invention consists in that, for example, a pedal kickback may be easily prevented or reduced. Because the ring unit and the freewheel component are movable in the circumferential direction relative to one another, a rotational path may be specified, starting from which a torque transmission may first be carried out.

Such a configuration may not only positively prevent a pedal kickback. Such a function may also generally make sense in freewheel systems, in order to provide a defined and substantially identical operating mode. In known freewheel systems, a rotational angle, before a force transmission occurs, is dependent on the configuration of the freewheel components and the random position of the two freewheel components with respect to each other. Due to the configuration according to the invention, a substantially identical rotational angle, before a torque transmission occurs, may always be provided. This rotational angle is then defined by the circumferential distance between the driving position and the rest position.

Another advantage of the bicycle component according to the invention is that it may also be possible to retrofit existing hubs, which previously did not have this feature. Due to a simple exchange of the ring unit and/or the freewheel components, an existing bicycle hub may be retrofitted.

Due the invention, a kickback of the pedals, due to a reverse driving of the chain, may be reduced or prevented, so that its resulting contribution to the rider fatigue may be prevented. Even if a pedal kickback is often not recognized as such by the rider, due to the unevenness of the road or terrain, the effective forces contribute substantially to rider fatigue.

A reverse rotation of the drive train, and thus also the crank, may be substantially reduced by the invention, and, in particular, completely prevented. A pedal kickback, and the resulting faster fatiguing of the rider, may cause decisive disadvantages with respect to the efficiency. This is reliably reduced or practically or completely prevented by the invention in a simple way.

In preferred refinements, the coupling components respectively have a radial toothing with projecting radial teeth, and radial grooves (as a coupling toothing) arranged therebetween. It is thereby preferred that the radial toothing of the one coupling component is designed as an outer radial toothing, and the radial toothing of the other (and thus interacting) coupling component is designed as an inner radial toothing.

In preferred embodiments, the outer freewheel component has an outer radial toothing and the ring unit comprises an inner radial toothing. It is also conceivable that the freewheel component has an inner radial toothing, which interacts with an outer radial toothing on the ring unit.

In preferred embodiments, when used as intended, at least one radial tooth of the outer radial toothing is arranged in a radial groove of the inner radial toothing of the ring unit, in order to transmit or be able to transmit a torque in the driving direction in the driving position.

It is particularly preferred that a circumferential length of at least one radial groove is substantially larger than a corresponding circumferential length (on a or the same diameter about the central axis) of a radial tooth (engaging therein). Correspondingly, at least one radial groove extends over a substantially larger circumferential angle as a corresponding circumferential angle of a radial tooth. This means that the radial tooth is accommodated within the radial groove with a substantial movability (in the circumferential direction). The term “substantially greater” is thereby understood to mean that not only a minimal play is present, as is necessary, for example, for the insertion, but rather that a substantial relative movement is possible. For example, the coupling components may be pivoted relative to one another by an angle of 2.5° or 5° or 10° or 15° or 20° or more, before the radial tooth strikes the boundary on the other end of the radial groove. Using the different circumferential lengths, a corresponding angular adjustment may be provided. It is particularly preferred (in at least one position) to provide a pivot angle between the coupling elements of at least 5° (between a rest position and a driving position).

In preferred embodiments, the outer freewheel component is able to be coupled to the ring unit in at least two different positions (and, in particular, usable therein). Different pivot angles between the coupling components are thereby provided in the different positions. This means that, for example, radial grooves are provided with different circumferential lengths. Due to a mounting or the insertion of a radial tooth (or the radial teeth) into a correspondingly long radial groove (or radial grooves), a corresponding pivot movement is enabled. Thus, the bicycle components may offer different, and also multiple different, settings in a simple way. The rider may easily carry out the changing of the settings, and preferably without tools. Thus, the rider may also make multiple different settings in succession on a single ride. It is thereby also possible that in one position, a pivot angle of (virtually) 0° is possible, so that the function is removed from service in this position.

A plurality or group of identical radial teeth and/or radial grooves is particularly preferably arranged distributed on the circumference of at least one of the coupling components.

Preferably, at least two groups of different radial teeth and/or radial grooves (with different circumferential extensions) are arranged distributed on the circumference of at least one of the coupling components. For example, two or three different divisions may thereby be provided. This enables, for example, the setting of 2 settings of different degrees and, for example, one setting, in which the two coupling components are positioned (practically) without play with respect to one another.

A ring unit may preferably be an integral (and one-piece) component of the hub housing unit. Or the ring unit may be designed separately and inserted (rotationally fixedly) into the hub housing. The ring unit is then, in particular, screwed into the hub housing.

The hub housing may, for example, be manufactured from a lighter metal, while the ring unit may be formed from a stronger and heavier material. In preferred embodiments, the ring unit is designed as a threaded ring, which has at least one thread start on the outer circumference and is screwed into the hub housing.

In advantageous embodiments, a biasing means is provided, which biases at least one freewheel component into an engagement position or into the freewheel state.

It is possible that the coupling components are biased into a rest position. The rest position is thereby not the driving position. The rest position is thereby independent of whether the freewheel components of a freewheel are in engagement with one another (engagement position), or whether the two freewheel components are out of engagement with one another (freewheel state). The rest position of a freewheel component is the position in which a torque transmission is not (immediately) possible using this freewheel component. A torque transmission is only possible if both coupling components have moved into the driving position. That means, in this case, that the freewheel components must first move, relative to the ring unit, in the circumferential direction from the rest position into the driving position, before a torque transmission may be carried out via these freewheel components. Independently from this, both freewheel components of a freewheel device must be transferred into or be in an engagement state for an effective torque transmission.

It is possible to provide a biasing means, with which it is ensured that the freewheel components are always located in the rest position without external influences. Such a biasing means may comprise, for example, one or more spring units. It is also possible, that by exploiting friction, the freewheel components may move themselves into the (or a) rest position when the rider is not pedaling.

In simple embodiments, a helical spring is included, which extends about the central axis, and which biases the pawls of an inner freewheel component into the engagement position.

In preferred embodiments, the bicycle component comprises at least one damping element, which is accommodated between the coupling toothings of the two coupling components. The damping element may consist, for example, of an elastic material (made, for example, from an elastic material for, for example, rubber or the like), and may reduce the generation of noises, in particular, during the transfer into the driving position and/or into the rest position.

In advantageous embodiments, at least one exchangeable setting unit is accommodated on one coupling component or freewheel component, in order to set an (adjusted and variable) setting of the circumferential path or pivot angle between the driving position and the rest position. By exchanging the setting unit, other circumferential paths and thus characteristics may be correspondingly provided. The setting unit may also function as a damping element.

In all embodiments, it is possible that at least one tooth shape on at least one radial tooth is designed as angular, rounded, or oblique in at least one circumferential direction.

In all embodiments, it is also possible that at least one radial toothing is designed as a radial helical toothing. This is understood in this case to include a toothing, in which the teeth are provided radially inwardly and/or radially outwardly, and in which the tooth flanks do not run parallel to the central axis, but instead at an angle thereto.

A further bicycle component according to the invention is provided for at least partially muscle-powered vehicles, and, in particular, bicycles and comprises a hub housing unit and a rotor, which is mounted to be rotatable with respect to a hub axle, wherein a freewheel device is provided between the hub housing unit and the rotor. The freewheel device comprises (at least) two freewheel components, namely a radially outer freewheel unit with an inner toothing and a radially inner freewheel unit with a pawl carrier and pawls accommodated thereon for engaging into the inner toothing of the radially outer freewheel unit, in order to transfer a driving power in the driving direction. The hub housing unit and the radially outer freewheel component are designed as separate coupling components, which are couplable with one another, and respectively have a radial toothing for engaging into one another and are mutually rotatable about a central axis of rotation.

In at least one installation position, the hub housing unit and the radially outer freewheel component are thereby movable in the circumferential direction by a defined pivot angle relative to one another between a driving position and a rest position, so that, prior to the beginning of a torque transmission, a coupling component must first be rotated in the driving direction until a torque transmission is/may be carried out, if the two radial toothings were previously located in the rest position. In the driving position, a torque may then be transmitted in the driving direction.

The hub housing unit may comprise a hub housing with an integrally-designed coupling contour. Or the hub housing unit comprises a hub housing and a separate ring unit with a coupling contour (integrally) designed thereon.

This bicycle component according to the invention also has many advantages.

The hub housing is preferably mounted to be rotatable using at least two hub bearings spaced axially apart from one another, namely at least one rotor-side hub bearing arranged closer to the rotor and at least one outer hub bearing farther away from the rotor. In particular, the rotor is mounted to be rotatable using at least two rotor bearings spaced axially apart from one another, namely a hub-side rotor bearing arranged closer to the hub housing and an outer rotor bearing farther away from the hub housing.

One substantial advantage of the invention lies in the simple design and the high reliability.

In advantageous refinements, the ring unit is accommodated radially inside of the hub housing. The hub housing unit provides a coupling contour via the hub housing or the ring unit, so that a coupling component is provided, which is coupled to the radially outer freewheel component as a further coupling component. The radially outer radial toothing of the outer freewheel component and the radial inner radial toothing of the hub housing unit are designed such that, in at least one position (also called the assembly position), a predefined pivot angle is provided between the coupling component. The predefined pivot angle extends far past a play required for assembly, and reduces or prevents pedal kickback.

Roller bearings, which respectively have a plurality of rolling elements, are preferably used for at least one hub bearing and for at least one rotor bearing. Deep groove roller bearings are preferably used, which have an inner ring and an outer ring. A spacing element is preferably provided between the rotor-side hub bearing and the hub-side rotor bearing. For example, a thin disc or a short sleeve may be provided as the spacing element in order to enable an independent rotation of the respective outer ring of the relatively closely adjacent roller bearings.

In is particularly preferred in all embodiments that the hub housing is mounted to be rotatable, in particular, directly on the hub axle using the hub bearings. It is likewise preferred that the rotor is mounted to be rotatable, preferably directly on the hub axle, using the rotor bearings. However, it is also conceivable that a hub bearing or a rotor bearing is arranged on a type of sleeve or the like, which in turn is accommodated or arranged on the hub axle. It is also possible that the rotor is mounted on a side via the hub housing unit.

It is possible that the ring unit is designed as a threaded ring and is produced from a more resilient material than the hub housing. For example, the threaded ring may be manufactured from steel. However, it is also possible that the threaded ring is manufactured from a lighter material, like, for example, aluminum or titanium or a corresponding alloy. Should wear occur on the radial toothing in the threaded ring, said threaded ring may be removed and exchanged as needed.

The outer thread of the threaded ring preferably comprises at least two separately designed and continuous thread starts. The inner thread in the hub housing preferably comprises at least two separately designed and continuous thread starts. By this means, a thread may be designed, which enables a high load capacity and simultaneously generates only a minor axial force during pedaling.

During riding, the threaded ring is basically driven farther into the hub housing by the driving force of the rider, as the driving force is transmitted via the outer radial toothing of the toothed disc device and the radially inner toothing on the threaded ring to the same. By this means, a screw torque is generated, which may lead to a spreading apart of the hub housing. By using a multi-turn thread at the same strength, the load in the hub housing may be reduced and thus a spreading apart of the hub housing may be prevented.

Additional advantages and features of the present invention arise from the exemplary embodiments, which are subsequently explained in greater detail with reference to the appended figures.

### BRIEF DESCRIPTION OF THE DRAWINGS

As shown in the figures:

FIG. 1 a schematic depiction of a mountain bike;

FIG. 2 a schematic depiction of a racing bike;

FIG. 3 a perspective depiction of a hub according to the application;

FIG. 4 a front view of the hub according to FIG. 3;

FIG. 5 a sectional view A-A through the hub according to FIG. 4;

FIG. 6 an exploded depiction of a hub according to the application;

FIG. 7 a schematic, perspective view of the rotor of the hub according to FIG. 5;

FIGS. 8a, b a ring unit and an outer freewheel component of a hub according to the application;

FIGS. 9a, b schematic developments of the toothings of the ring unit and outer freewheel component in different mounting positions;

FIG. 10 a schematic view of a ring unit and an additional component of a hub according to the application;

FIG. 11 a schematic view of a freewheel device and the ring unit for a hub according to the application;

FIG. 12 a schematic, sectional side view of a hub according to the application; and

FIG. 13 a schematic view of an inner freewheel component of a hub according to the application.

### DETAILED DESCRIPTION

A mountain bike and a racing bike 100 are respectively shown in FIGS. 1 and 2, which are respectively equipped with a bicycle component 1 according to the invention and designed as a hub 50. The mountain bike or the racing bike 100 respectively has a front wheel 101 and a rear wheel 102. A hub 50 is used in each case on the rear wheel 102. The two wheels, 101, 102 have spokes 109 and a rim 110 and a sprocket device 111. In principle, conventional rim brakes or also other brakes, like disc brakes, for example, may be provided.

A bike 100 has a frame 103, handlebars 106, a seat 107, a fork or suspension fork 104, and, in the case of mountain bike, a rear wheel suspension 105 may be provided. A pedal crank 112 with pedals functions as the drive. Optionally, an electric auxiliary drive may be provided on the pedal crank 112 and/or the wheels. The hub 1 of the wheels may respectively be fastened to the frame via a tensioning device (e.g. through axle or quick release).

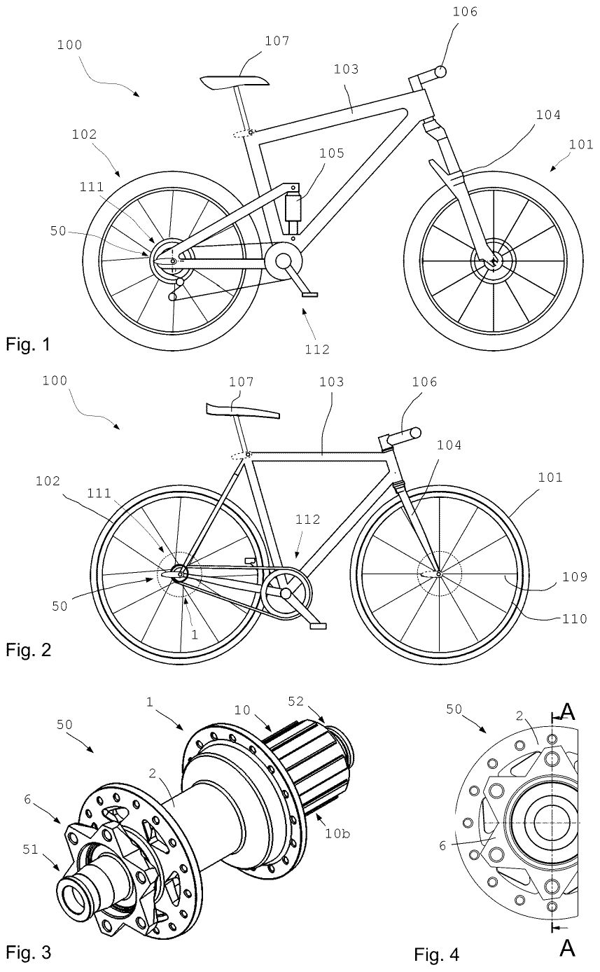

FIG. 3 shows the hubs 50, used respectively on the rear wheel 102 in the bicycles according to FIGS. 1 and 2, in a perspective view, and FIG. 4 in a front view.

The hub 50 has a hub housing unit 2 and a rotor 10 and also a brake disc mount 6. A sprocket mount for receiving a cassette with a corresponding number of sprockets is provided on the outside of the rotor 10. End stops 51, which are plugged on in this case, but may also be inserted or screwed on, if necessary, are provided on the two ends of the hub 50. As is clear here, the end stops 51 are designed as hollow and function for receiving a clamping axle, with which the hub 1 may be fixed to the frame.

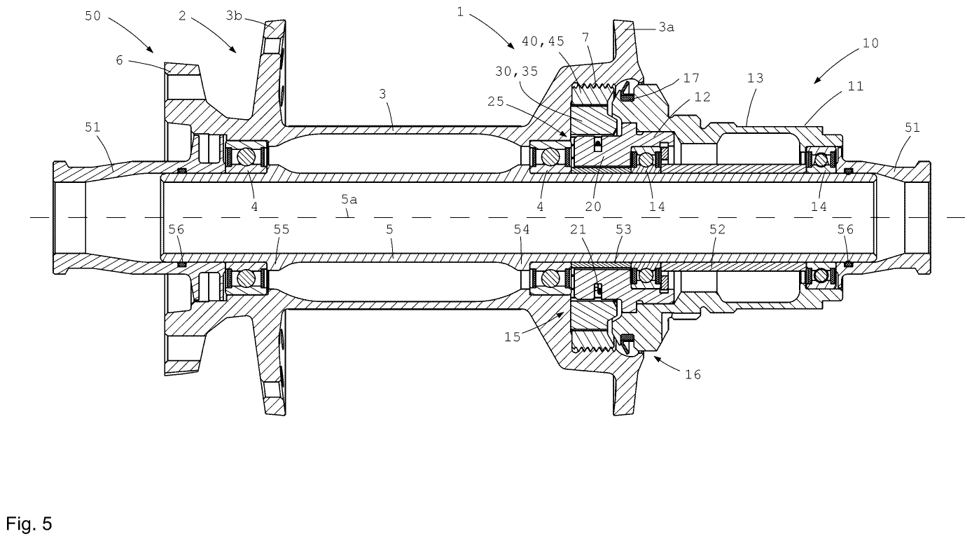

FIG. 5 shows the sectional view A-A from FIG. 4. The hub 50 here has, e.g., an installation length of 148 mm. The hub 50 comprises the hub axle 5, designed as hollow, on which the hub housing 2 is mounted to be rotatable via the hub bearings 4. The rotor 10 is likewise mounted, in this case directly on the hub axle 5, to be rotatable via roller bearings 14.

A thickening 54 with a radial shoulder is designed on the hub axle 5 closer to the rotor 10, and a thickening 55 with a radial shoulder is designed on the outer end underneath the hub flange 3b. The rotor-side hub bearing 4 contacts the radial shoulder of the thickening 54 and the outer hub bearing 4, arranged on the other end of the hub housing 3, contacts the shoulder of the thickening 55 of the hub axle 5. Axially outward, the end stop 51 connects to the outer hub bearing, is pushed onto the hub axle 5 in this case, and seals the hub housing toward the outside via a double flange projecting outwardly.

In the direction toward the rotor 10, a spacing element 53 connects to the rotor-side hub bearing 4 and then to the hub-side rotor bearing 14. A sleeve 52 is pushed onto the hub axle 5 as a spacing element between the hub-side rotor bearing 14 and the outer rotor bearing. Axially outward, the end stop 51 connects to the outer rotor bearing 14. The hub 50 is firmly clamped in the frame.

The hollow hub axle 5 has an inner clear diameter, which may be, depending on the configuration, 12 mm, 15 mm, or also 16 mm or 17 mm or more. Due to the hollow hub axle 5, a clamping axle of a clamping device may be pushed through in order to fasten the hub 50 to a frame of a bicycle. At one end, the clamping axle may have, for example, an end piece with an outer thread, with which the clamping axle may be screwed into a corresponding thread on the frame. At the other end, a corresponding clamping mechanism may be provided in order to reliably accommodate and clamp the hub 50 to a frame.

According to the application, the hub bearings 4 and also the rotor bearings 14 are respectively designed as roller bearings and respectively have a plurality of rolling elements. In this case, in the exemplary embodiment, the roller bearings are all designed as deep groove ball bearings.

The hub 50 is firmly clamped in the frame in the axial direction. The force flow thereby runs, for example, from the left end in FIG. 5 through the end stop 51, the inner bearing ring of the outer hub bearing 4 and across the shoulder of the thickening 55 into the hollow hub axle 5. From there, the introduced force is guided across the shoulder of the thickening 54 into the inner bearing ring of the other hub bearing 4 and through the spacing element 53 between the rotor-side hub bearing and the hub-side rotor bearing 14. From there, the force enters into the inner bearing ring of the hub-side rotor bearing 14, and is guided via the sleeve 52 to the bearing inner ring of the outer rotor bearing 14, and from there through the end stop 51 back into the frame. The hub housing 3 and the rotor 10 are held radially and axially by the deep groove roller bearings.

The hub housing 3 has a hub flange 3a on the rotor side and a hub flange 3b on the other side. The spokes may be fastened to the hub flanges 3a, 3b. A brake disk mount 6 is provided on the other and outer hub end opposite the rotor 10.

The gap between the hub housing 3 and the rotor 10 is sealed via a sealing device 16, which may comprise a sealing gap and an elastic sealing lip of a seal 17.

Radially inside of the rotor-side hub flange 3a, a ring unit 45 in the form of a threaded ring 40a is screwed in the hub housing as a coupling component 40. The ring unit 45 designed as a coupling component 40 has a radially inner toothing 41 as a coupling toothing. Accommodated therein is the radially outer freewheel component 35 of the freewheel device 15, which forms a further coupling component 30. The coupling components 30, 40 are pivotable relative to one another in order to reduce or to prevent a pedal kickback.

The freewheel device 15 also comprises the radially inner freewheel component 25, which is arranged radially inside of the outer freewheel component 35. The inner freewheel component 25 is connected in this case to the two-part rotor 10, which comprises a first rotor part 11 and a second rotor part 12.

The sprocket mount 13, on which a cassette with multiple sprockets may be accommodated, is designed on the first rotor part 11. The first rotor part 11 and the second rotor part 12 are non-rotatably connected to one another and in this case are, e.g., screwed to one another.

A pawl carrier 20, on which the pawls 26 are accommodated in the pawl seats 27 (see FIG. 7), is designed in this case on the second rotor part 12. The pawls 26 of the radially inner freewheel component 25 engage into an inner toothing 36 of the radially outer freewheel component 35 for torque transmission (see FIGS. 7 and 11).

The rotor 10 is able to be non-rotationally connected in the driving direction to the rotor 10 or to the hub housing 3 via the freewheel components 25, 35.

It is possible that the coupling components 30, 40 are pushed into the rest position “R” when the rider does not pedal. It is possible that one of the coupling components 30, 40 is pivotable between the rest position “R” and the driving position “A” and is biased into the rest position “R”. It is, however, also possible that both coupling components 30, 40 are respectively pivotable between a respective rest position “R” and the driving position “A”. The respective pivot angles may be identical or also different.

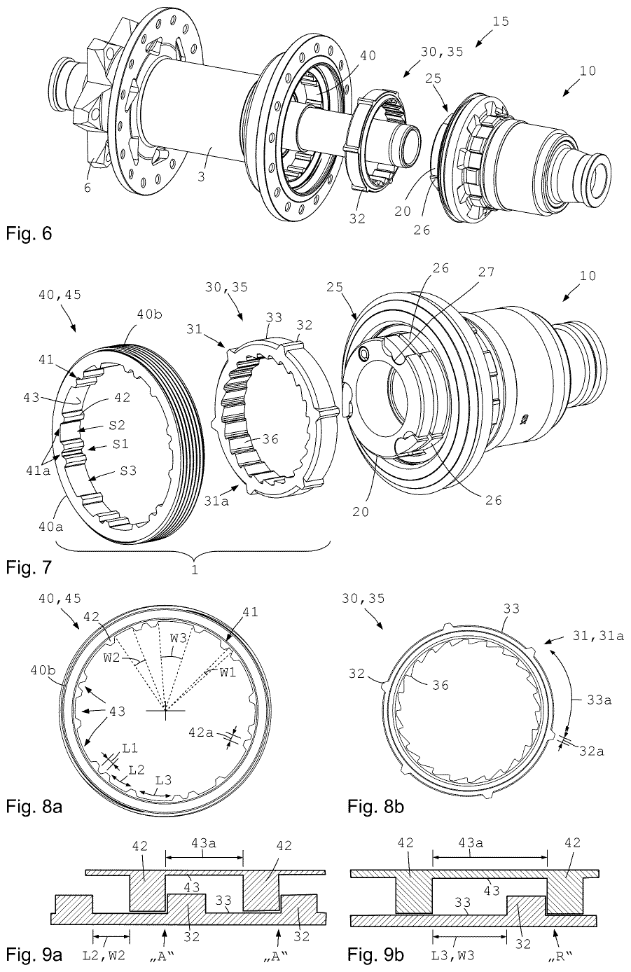

FIGS. 6 and 7 show perspective views of bicycle components 1 or bicycle hub 50 according to the invention. A bicycle hub 50 comprises a hub housing 3 and a rotor 10, and is equipped with two freewheel components 25 and 35 via a freewheel device 15.

It is clear in FIG. 6 that a coupling component 40 is accommodated or designed in the hub housing 3. The hub housing unit 2 is formed in this case by the hub housing 3 and the coupling component 40 accommodated therein. The radially outer freewheel component 35 is in turn accommodated as coupling component 30 in the coupling component 40. The outer radial teeth 32 of the coupling toothing 31 (outer toothing) thereby ensure that a torque transmission is possible.

FIG. 7 shows a specific configuration of a bicycle component 1, wherein this comprises the coupling components 30 and 40. The ring unit 45 forms the coupling component 40 and in this case is designed as a threaded ring 40a, which may be screwed into the hub housing 3. The ring unit 45 tapers across an inner coupling contour in the form of an inner coupling toothing 41, which has multiple (radially inwardly projecting) radial teeth 42, which are arranged in this case in groups distributed across the inner circumference. Radial grooves 43 are designed or arranged between the individual radial teeth 42, wherein the circumferential lengths 43a (L1, L2, and L3) of different radial grooves 43 differ significantly from one another. A circumferential width 42a of the radial teeth 42 is designed to be respectively identical in this case.

As FIG. 7 shows, the radial teeth 32 are narrower in the circumferential direction than many of the radial grooves 43. When the radial teeth 32 are introduced into the positions S2 or S3, the coupling components 30, 40 are accommodated pivotably relative to one another. The outer radial teeth 32 are thereby accommodated pivotably in the radial grooves 43 between the inner radial teeth 42 of the ring unit 45 as coupling components 40.

On the right, next to the ring unit 45, a radially outer freewheel component 35 is depicted, which functions as coupling component 30. The outer freewheel component 35 has an inner toothing 36, wherein the pawls 26 in an engagement position engage into some teeth of the inner toothing 36 in order to transmit torque.

In this case, the radially outer freewheel component 35 may be introduced into the ring unit 45 in three different positions S1, S2, and S3. Depending on the installation situation, the two coupling components 30, 40 may be pivoted to different degrees with respect to one another, until the drive torque may be transmitted.

As FIGS. 7, 8a, 8b and 9a, 9b show, three pivot angles W1, W2, and W3 may be implemented in this case, before the coupling components are transferred from a rest position “R” into a driving position “A”.

The radially outer freewheel component 35 has, in this case, a radial toothing 31, which functions as a coupling contour 32, and a has a plurality of radial teeth 32. A radial groove 33, which respectively has a/an (identical) circumferential length 33a in this case, which is substantially larger than a circumferential length 32a of a radial tooth 32, is provided respectively between the radial teeth 32 in this case.

The outer dimensions of the coupling components 30, 40 are determined with respect to one another such that the outer freewheel component 35 may be accommodated in the inside of the ring unit 45. The radial teeth 32 are thereby guided into the radial grooves 43.

Depending on which of the radial grooves 43 the radial teeth 32 are introduced into, the outer freewheel component 35 is accommodated with or without play in the ring unit 45. Upon introduction into the radial grooves 43 with a circumferential length L1, there arises little or even no angular adjustability. If the radial teeth 32 are introduced into radial grooves 43 with a circumferential length L2, there arises an average adjustability, and upon introduction into radial grooves 43 with a circumferential length L3, a large angular adjustment arises.

Multiple groups of radial grooves 43 are provided across the circumference or across the inner circumference of the ring unit 45.

FIGS. 9a and 9b strongly schematically show different developments of the toothings of the two coupling components 30, 40 engaging into one another.

In FIG. 9a, a radial groove 43 with a circumferential length 43a is provided between two depicted radial teeth 42. A radial tooth 32 of the inner coupling component (=radially outer freewheel component 35) engages into this radial groove 43. There arises, using the circumferential length 42a of the radial tooth 42, a pivot angle W2 or a circumferential length L2 for the pivot movement between a rest position “R” and a driving position “A”. In FIG. 9a, the two coupling components are mounted in the assembly position or in position S2.

FIG. 9b shows an assembly position or position S3, in which a radial tooth 32 engages into a radial groove 43 between the two depicted radial teeth 42. The radial groove 43 has, in this case, a greater circumferential length 43a than in FIG. 9a. Taking into consideration the circumferential length 42a of the engaging radial tooth 32, there arises a pivot angle W3 or a circumferential length L3 for the pivot movement between a rest position “R” and a driving position “A”.

In FIG. 9a, an angular adjustability W2 of the two components 30, 40 with respect to one another arises, and in FIG. 9b, an angular adjustability W3 arises.

In FIG. 9a, the coupling components 30, 40 are depicted in the driving position “A”, and in FIG. 9b in the rest position “R”. In the driving position “A”, a torque may be directly transmissible, if the freewheel device 15 is located in the engagement position “E”. Otherwise, the freewheel components 25, 35 must be initially transferred from the freewheel state “F” into the engagement position “E”.

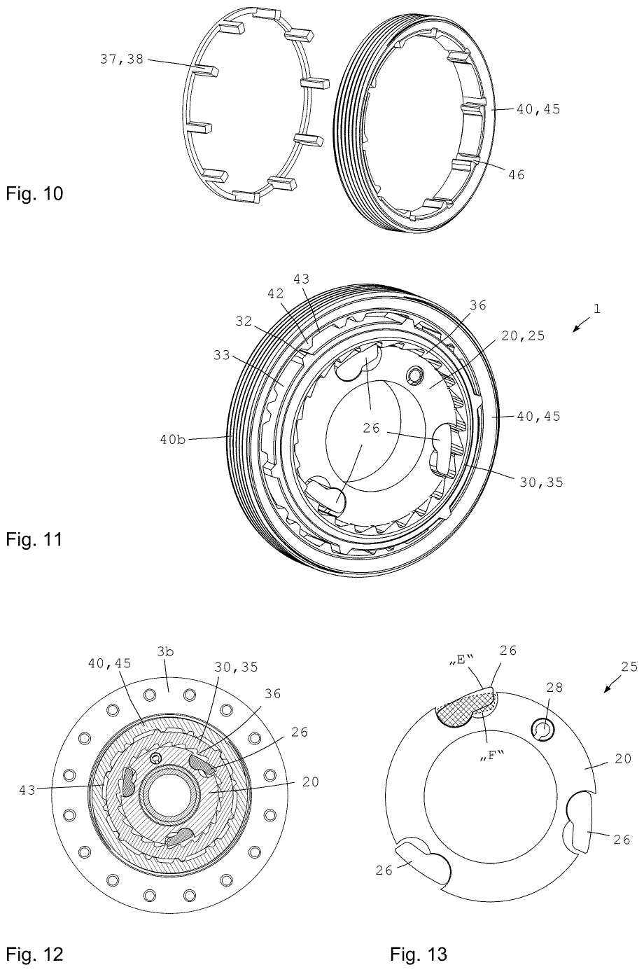

FIG. 10 shows a variant, in which an additional element, like a damping element 37 and/or a setting unit 38 is introduced, in order to damp noises in operation and/or to enable an adjustment of the angular adjustment or the path adjustment between the driving position and rest position. The additional element may be accommodated in the recesses or receptacles 36. However, it is also possible that no specific recesses 36 are provided.

The dimensions of the damping element or setting element may be correspondingly varied. The characteristics may be quickly modified by a simple exchange of the additional element 37, 38.

FIGS. 11 and 12 show a perspective depiction and a side view of the two coupling components 30, 40 or the ring unit 45 and the outer freewheel component 35 accommodated therein. The inner freewheel component 25 is, in turn, thereby accommodated radially inwardly therein. The pawls 26 on the pawl carrier 20 of the inner freewheel component 25 engage into the inner toothing 36 of the outer freewheel component.

FIG. 13 shows yet another separate view of the inner freewheel component 25 with the pawls 26 on the pawl carrier 20, wherein one pawl in the freewheel state “F” is indicated by cross-hatching. The pawls 26 are biased, in this case, into the engagement position “E” by an annular spring 28.

The threaded ring 40a may be screwed to the hub housing 2 via a multi-start thread. Two continuous and separate thread starts are respectively provided on the threaded ring 40a and on the hub housing.

As a whole, an advantageous bicycle component 1 is provided, which is simply designed. The bicycle component 1 may be designed as a hub 50, and is easy to assemble and has a relatively low number of parts.

A high stability is achieved. A “kickback” may be reliably prevented by the pivotability. The bicycle component 1 may be provided as a replacement set, by means of which a previous hub may be retrofitted with the function.

While a particular embodiment of the present bicycle component has been described herein, it will be appreciated by those skilled in the art that changes and modifications may be made thereto without departing from the invention in its broader aspects and as set forth in the following claims.

### LIST OF REFERENCE NUMERALS

1 Bicycle component
2 Hub housing unit
3 Hub housing
3a, 3b Hub flange
4 Hub bearing
5 Hub axle
5a Axis of rotation
6 Brake disc mount
7 Inner thread
10 Rotor
11 First rotor part
12 Second rotor part
13 Sprocket mount
14 Rotor bearing
15 Freewheel device
16 Sealing device
17 Seal
20 Pawl carrier
21 Annular spring
25 Freewheel component (inner)
26 Pawl
27 Pawl seat
28 Spring
30 Coupling component (inner)
31 Coupling toothing (outer)
31a Coupling contour (outer)
32 Radial tooth (outer)
32a Circumferential length (outer)
33 Radial groove (outer)
33a Circumferential length (outer)
35 Freewheel component (outer)
36 Inner toothing
37 Damping element
38 Setting unit
40 Coupling component (outer)
40a Threaded ring
40b Outer thread
41 Coupling toothing (inner)
41a Coupling contour (inner)
42 Radial tooth (inner)
42a Circumferential length (inner)
43 Radial groove (inner)
43a Circumferential length (inner)
45 Ring unit
46 Recess, receptacle
50 Bicycle hub
50, 51 End stop
52 Sleeve body
53 Spacing element
54, 55 Radial thickenings
56 O-ring, seal
100 Bicycle
101 Wheel, front wheel
102 Wheel, rear wheel
103 Frame
104 Fork, suspension fork
105 Rear wheel suspension
106 Handlebars
107 Seat
109 Spoke
110 Rim
111 Sprocket device
112 Pedal crank
F Freewheel state
E Engagement position
A Driving position
R Rest position
L1-L3 Circumferential lengths
S1-S3 Positions
W1-W3 Pivot angles

1. A bicycle component for an at least partially muscle-powered bicycle, having at least one ring unit and having at least one freewheel component of a freewheel device,
wherein the freewheel component is designed as a radially outer freewheel component and has an inner toothing, which is designed for engaging pawls of a radially inner freewheel component in order to transfer a driving power in the driving direction,
wherein the outer freewheel component and the ring unit are designed as coupling components able to be coupled to one another and respectively have a coupling toothing for engagement with one another and are mutually rotatable about a central axis of rotation,
in at least one installation position, the ring unit and the outer freewheel component are movable in the circumferential direction by a defined pivot angle relative to one another between a driving position and a rest position so that, prior to the beginning of a torque transmission, a coupling component must first be rotated in the drive direction before a torque transmission may be carried out, if the two coupling toothings were previously located in the rest position.

2. The bicycle component according to claim 1, wherein the coupling components respectively have a radial toothing with radially projecting radial teeth and radial grooves arranged therebetween as coupling toothing.

3. The bicycle component according to claim 1, wherein the radial toothing of the one coupling component is designed as an outer radial toothing and the radial toothing of the other and thus interacting coupling component is designed as an inner radial toothing.

4. The bicycle component according to claim 3, wherein, when used as intended, at least one radial tooth of the outer radial toothing is arranged in a radial groove of the inner radial toothing in order to transmit a torque in the driving direction in the driving position.

5. The bicycle component according to claim 1, wherein a circumferential length of at least one radial groove is substantially larger than a corresponding radial length (on a or the same diameter about the central axis) of a radial tooth engaging therein.

6. The bicycle component according to claim 1, wherein the outer freewheeling component is able to be coupled to the ring unit in at least two different positions, wherein different pivot angles between the coupling components are provided in the different positions.

7. The bicycle component according to claim 1, wherein a pivot angle between the coupling components of at least 5° is provided.

8. The bicycle component according to claim 1, wherein a plurality of identical radial teeth and radial grooves are arranged distributed on the circumference of at least one radial component.

9. The bicycle component according to claim 8, wherein at least two groups of different radial teeth and/or radial grooves are arranged distributed on the circumference of at least one radial component.

10. The bicycle component according to claim 1, wherein the ring unit is an integral component of the hub housing unit, or wherein the ring unit is designed as separate and is introduced into the hub housing, and is screwed in.

11. The bicycle component according to claim 1, wherein at least one damping element is accommodated between the two coupling components.

12. The bicycle component according to claim 1, wherein an exchangeable setting unit is accommodated between the two coupling components in order to set different circumferential paths between the driving position and rest position.

13. A bicycle component for at least partially muscle-powered bicycles, comprising: a hub housing unit and a rotor, which is mounted to be rotatable with respect to a hub axle; wherein a freewheel device is provided between the hub housing unit and the rotor;
wherein the freewheel device comprises two freewheel components, namely a radially outer freewheel unit with an inner toothing and a radially inner freewheel unit with a pawl carrier and pawls accommodated thereon for engaging into the inner toothing of the radially outer freewheel unit, in order to transfer a driving power in the driving direction;
wherein the hub housing unit and the radially outer freewheel component are designed as separate coupling components, able to be coupled with one another, and respectively have a coupling toothing for engaging into one another and are mutually rotatable about a central axis of rotation;
in at least one installation position, the hub housing unit and the radially outer freewheel component are movable in the circumferential direction by a defined pivot angle relative to one another between a driving position and a rest position, so that, prior to the beginning of a torque transmission, a coupling component must first be rotated in the driving direction before a torque transmission is/may be carried out, if the two radial toothings were previously located in the rest position.

14. The bicycle component according to claim 13, wherein the hub housing is mounted to be rotatable using at least two hub bearings spaced axially apart from one another, namely at least one rotor-side hub bearing arranged closer to the rotor and at least one outer hub bearing farther away from the rotor, and wherein the rotor is mounted to be rotatable using at least two rotor bearings spaced axially apart from one another, namely a hub-side rotor bearing arranged closer to the hub housing and at least one outer rotor bearing farther away from the hub housing.

15. The bicycle component according to claim 13, wherein the ring unit is designed as a threaded ring and is screwed into the hub housing.
